(19) United States
(12) Patent Application Publication
(10) Pub. No.: US 2015/0376557 A1
(43) Pub. Date: Dec. 31, 2015

(54) DEVICE AND METHOD FOR HEATING A FERMENTABLE STARTING PRODUCT IN ORDER TO PRODUCE A BEVERAGE

(71) Applicant: O. SALM & CO. GES.M.B.H., Wien (AT)

(72) Inventor: Albert WELLEDITS, Wien (AT)

(21) Appl. No.: 14/768,164

(22) PCT Filed: Feb. 14, 2014
(86) PCT No.: PCT/EP2014/052892

§ 371 Date: Aug. 14, 2015

(30) Foreign Application Priority Data
Feb. 15, 2013 (DE) 10 2013 202 481.9

(51) Int. Cl. C12C 7/22; C12C 7/06

(52) U.S. Cl. CPC C12C 7/22; C12C 7/06

(57) ABSTRACT

A device and a method for heating a fermentable starting product in order to produce a beverage, comprises a line which is arranged inside a combustion chamber and via which a part of a heat outputted from a heat source in the combustion chamber by a first heat transporting medium can be transferred to the fermentable starting product flowing in the line. A heat storage device arranged downstream of the combustion chamber is used for storing a part of the residual heat transported by means of the first heat transporting medium. The line is arranged such that the fermentable starting product flowing in the line is pre-heated upstream of the combustion chamber in a pre-heating chamber by the heat stored in the heat storage device.

The invention relates to an apparatus and a method for heating a fermentable starting material for beverage production according to the preamble of claim 1 and claim 10, respectively.

Document EP 1715031 B1 discloses an apparatus and a method for providing water or steam as a heating medium in a process. Here, a zeolite heat storage device is used to heat combustion air.

Document DE 93 11 514.8 U1 discloses a heater in which a preheating of a medium flowing in a line takes place by means of a residual heat of a first medium.

Besides, the prior art already describes a device for heating brewing mash which is disclosed in document AT 390 266 B. In this device, a line through a regularly wound (helical) tube is formed, said tube being located within a combustion chamber. The line is connected to a heat source in heat-transferring contact, whereby the brewing mash flowing through the line is heated. Such a device is also known as so-called “external boiler”. In devices such as the one described with reference to document AT 390 266 B, it is possible to gently heat an arbitrary fermentable fluid within a short time using a comparatively high temperature. Document AT 390 266 B is considered to be the closest prior art.

Due to the comparatively high temperatures used in the external boiler described above, a large amount of waste heat occurs. For ecological and economic reasons, there is a need to use this waste heat in a meaningful way.

A device for heating a fermentable starting material according to the invention comprises a line which is arranged inside a combustion chamber and by which part of a heat outputted from a heat source in the combustion chamber by a first heat transporting medium is transferable to the fermentable starting material flowing in the line. A heat storage device is provided downstream of the combustion chamber for storing part of the residual heat transported by the first heat transporting medium. Said line is arranged such that, upstream of the combustion chamber, preheating of the fermentable starting material flowing in the line takes place in a preheating chamber by the heat stored in the heat storage device.

Fermentable starting materials according to the invention can be all mixtures of substancesor pure substances which contain at least one fermentable substance. A fermentable substance in the context of the invention is a chemical compound which can be used under anaerobic and/or aerobic conditions by microorganisms, such as yeasts and bacteria, as energy and carbon source, respectively. In particular, monosaccharides, disaccharides and polysaccharides are included here. Particularly preferred are fermentable starting materials which contain at least one of fructose, glucose, sucrose, maltose (malt sugar) or starch or one of their degradation products.

In particular, this includes starting materials for the production of beer such as mash, brewer's wort, derived after products, raw fruits dissolved in water (such as rice or corn). A combustion chamber for the purposes of the invention is to be understood to be not only a space in which a combustion of a suitable fuel such as oil, wood or gas takes place but in general, a space in which a heat is transferred from a heat source via a heat transporting medium to the line and via the same to the fermentable starting material.

According to the invention, a large part of the waste heat is stored in the heat storage device, which is provided downstream of the combustion chamber. By providing a line arrangement according to the invention, the fermentable starting material flowing in the line can be preheated by the heat stored in the heat storage device. On the one hand, this allows a more precise regulation of the amount of heat that is supplied to the fermentable starting material in the area of the combustion chamber and, on the other hand, also enables massive saving of energy.

Advantageously, a transfer of part of the residual heat can take place between the combustion chamber and the heat storage device from the first heat transporting medium to a second heat transporting medium. Thus, for example, the residual heat of a gaseous heat transporting medium such as an exhaust gas of a combustion process can be transferred to a liquid heat transport medium such as water or thermal oil, which simplifies handling thereof.

Use of thermal oil can be particularly advantageous, since thermal oil can be heated for example by means of electric heating elements, thereby avoiding an exhaust pollution of the environment when using appropriate power generation (wind power, solar power, hydro power). In addition, thermal oil can be used for higher temperature ranges without change of its state of aggregation or its pressure since, under ambient pressure its boiling point is more than 300° C. Therefore, use of thermal oil at temperatures ranging up to 300° C. is possible. In addition, the energetic efficiency of thermal oil is much better than that of e.g. water or steam.

Advantageously an amount of the second heat transport medium in the preheating chamber maximally corresponds to an amount of the fermentable starting material in the line in the preheating chamber. This means that the volume of the second heat transporting medium within the preheating chamber, for example a thermal oil, is not greater than that of the fermentable starting material currently heated thereby. Due to the favorable volume ratios between the first heat transporting medium and the fermentable starting material via the product of temperature and volume per unit time, the amount of heat supplied to the fermentable starting material can be feedback controlled with high accuracy.

In a particularly advantageous manner, the part of the residual heat can be transferred in a feedback controlled way. Thus, it can be ensured that the transfer of the residual heat only takes place when the first heat transporting medium has reached a certain minimum temperature.

Advantageously, the transfer of part of the residual heat from the first heat transporting medium to the second heat transporting medium can be effected by means of a branch, a switching valve, a fluid pump or a fan. Preferably, the first heat transporting medium is conducted via one or more of these elements to a heat exchanger where the heat is transferred to the second heat transporting medium.

Advantageously, the heat storage device may be provided in the form of at least one latent heat storage device. In the latent heat storage device a transfer of heat from the heat transporting medium to a phase change material or vice versa takes place. The use of a latent heat storage device allows storing of the heat for an almost unlimited period. Accordingly, after completion of a cooking process using the inventive device for heating a fermentable starting material, a new cooking process can be started from the very beginning with a preheated fermentable starting material even after a prolonged rest period, because the heat in the latent heat storage device can be stored for an almost unlimited time. By using the heat stored in the latent heat storage device for preheating the fermentable starting material, said fermentable starting material advantageously reaches the combustion chamber already at an elevated temperature and is heated further there. Therefore, in order to obtain a target temperature of the fermentable starting material, merely a smaller amount of heat is necessary.

Preferably a salt or a paraffin is used as phase change material. Preferably, the condensation temperature of the phase change material is between 130° C. and 150° C., most preferably the temperature is 145° C. Its recrystallization temperature is preferably between 130° C. and 120° C.

Advantageously, control means may be provided so as to control a supply of the second heat transporting medium to the preheating chamber and/or the latent heat storage device based on a temperature of the first heat transporting medium downstream of the combustion chamber and/or a temperature of the second heat transporting medium downstream of the preheating chamber.

This allows discharging or charging of the latent heat storage device while simultaneously preheating the fermentable starting material or merely charging of the latent heat storage device without preheating the fermentable starting material at the same time.

The control means can advantageously be provided in the form of a charge pump and a discharge pump. In this case, the charge pump in a switched-on state and the discharge pump in a switched-off state effect a flow of the second heat transporting medium through the latent heat storage device in a first direction. This corresponds to a state in which only the latent heat storage device is supplied with the second heat transporting medium and only will be loaded without preheating of the fermentable starting material taking place.

The charge pump in a switched-off state and the discharge pump in a switched-on state cause a flow of the second heat transporting medium through the preheating chamber and the latent heat storage device in a second direction. In this state, merely preheating of the fermentable starting material takes place. Preferably, this is the case when, after a downtime, a new manufacturing cycle is started. Then, the comparatively cold fermentable starting material is preheated especially with the heat from the latent heat storage device, as the desired operating temperature in the combustion chamber has not yet been reached.

When the charge pump and the discharge pump are in a switched-on state, they cause a flow of the second heat transporting medium through the preheating chamber and the latent heat storage device in the first direction. In this case, charging of the latent heat storage device as well as preheating of the fermentable starting material takes place.

Advantageously, to heat a fermentable starting material the device may be configured as an external boiler.

An inventive method for heating a fermentable starting material comprises the steps of: transporting the fermentable starting material through a line, heating the fermentable starting material by transferring part of a heat outputted from a heat source via a heat transporting medium to the fermentable starting material flowing in the line in a combustion chamber, storing part of the residual heat transported by the heat transporting medium in a heat storage device downstream of the combustion chamber, and preheating the fermentable starting material flowing in the line upstream of the combustion chamber by the heat stored in the heat storage device in a preheating chamber.

Preferably, a maximum temperature of the first heat transporting medium may be around 168° C., in particular if the first heat transporting medium is an exhaust gas occurring from combustion. The starting material to be fermented may reach this temperature also in the region of the combustion chamber.

Advantageously, part of the residual heat can be transferred between the combustion chamber and the heat storage device from the first heat transporting medium to a second heat transporting medium. This enables, for example, the heat transfer from a gaseous heat transporting medium, such as a combustion exhaust gas to a liquid heat transporting medium, thereby simplifying its handling.

Advantageously, the temperature of the first heat transporting medium during the transfer of the heat to the second heat transporting medium can be in a range between 100° C. and 170° C. Preferably, it is not more than 168° C. The temperature of the second heat transporting medium, which can be conducted in a closed circuit guided via the heat storage device, can be increased up to 155° C. due to the heat transfer.

Advantageously, the heat is transferred from the second heat transporting medium to a phase change material in the heat storage device formed as at least one latent heat storage device, or vice versa.

Then

a) the preheating of the fermentable starting material flowing in the line is effected in the preheating chamber by discharging the latent heat storage device, by causing the second heat transporting medium to flow from the latent heat storage device to the preheating chamber when the temperature of the first heat transporting medium is below a predetermined limit temperature,

b) the preheating of the fermentable starting material flowing in the line is effected in the preheating chamber while the latent heat storage device is charged, by causing the second heat transporting medium to flow in a closed circuit via a heat exchanger at which heat is transferred from the first heat transporting medium to the second heat transporting medium, through the latent heat storage device and the preheating chamber, and

c) only a charging of the latent heat storage device is effected by causing an access to the preheating chamber to be blocked while the second heat transporting medium flows in the closed circuit via the heat exchanger at which heat is transferred from the first heat transporting medium to the second heat transporting medium, and through the latent heat storage device.

Thus, it is possible to use the heat stored in the latent heat storage device in an initial phase of a beverage production operation to preheat the fermentable starting material until a temperature in a combustion chamber reaches a set temperature. Thereafter it is possible to adapt the temperature in the combustion chamber by partly preheating and simultaneously charging of the latent heat storage device such that a desired temperature difference of the fermentable starting material upstream of the preheating chamber and downstream of the combustion chamber is achieved without excessive fuel consumption. In the final phase of the beverage production process, the preheating can then be switched off. In this case, by means of an elevated temperature in the combustion chamber, the fermentable starting material can be heated and the latent heat storage device can be fully recharged. That is, the phase change material is completely converted into the liquid phase in the latent heat storage device.

Advantageously, this

step a) can be carried out as long as a temperature of the first heat transporting medium downstream of the combustion chamber is below a predetermined minimum temperature and a minimum proportion of the phase change material is available in liquid form,

step b) can be carried out when the temperature of the first heat transporting medium has exceeded the predetermined minimum temperature downstream of the combustion chamber,

step c) can be carried out when the temperature of the first heat transporting medium has exceeded a predetermined charging temperature downstream of the combustion chamber (3).

When doing so, in step b) a temperature feedback control can be performed in the combustion chamber in dependence on a temperature difference of the fermentable starting material between a point upstream of the preheating chamber and downstream of the combustion chamber.

Further advantages of the invention will become apparent from the following description of the currently preferred embodiments which are given with reference to the attached figures.

In the drawings:

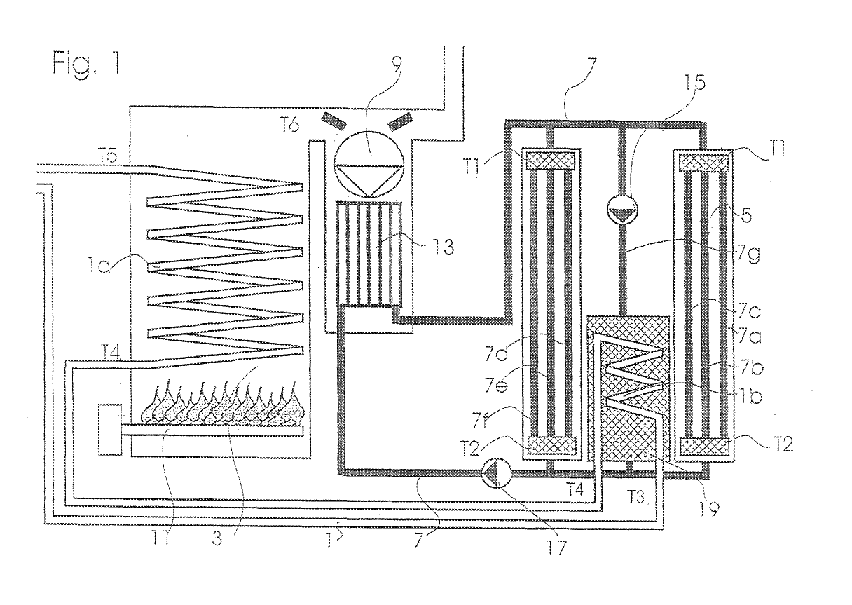

FIG. 1 is a schematic view of a device for heating a fermentable starting material according to a first embodiment of the invention, and

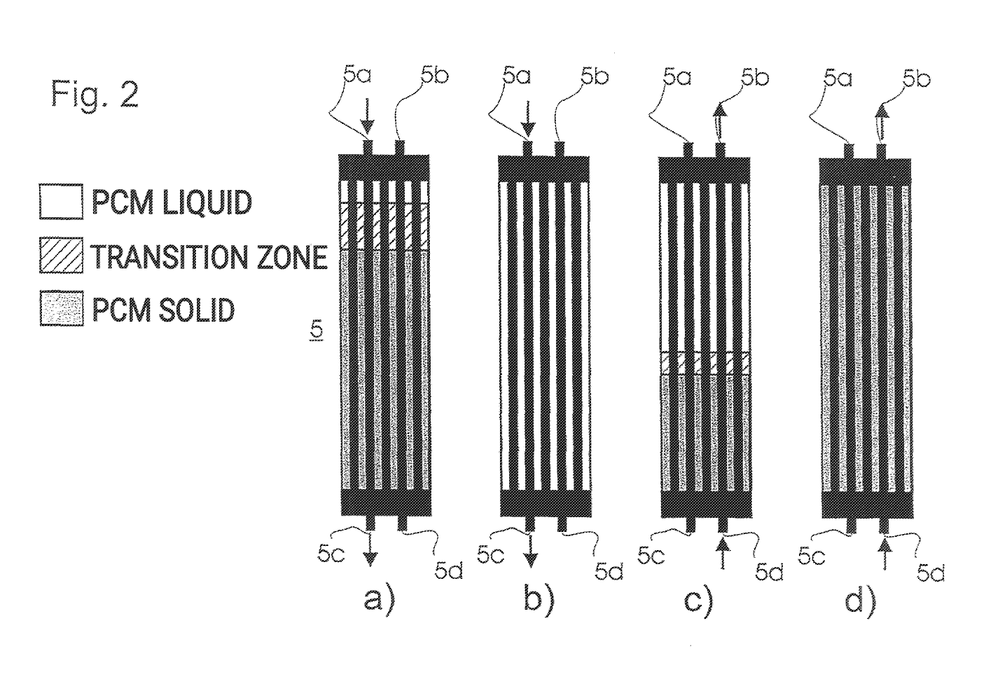

FIGS. 2 a) to d) schematically show a charging or discharging process of a latent heat storage device which is used as storage in a device for heating a fermentable starting material according to the invention.

A device for heating a fermentable starting material according to the invention is schematically shown in FIG. 1. As an example of the fermentable starting material, a mash is used in the following description. However, the exemplary use of mash does not exclude the use of the invention with other fermentable starting materials such as brewer's wort or derived after products such as raw fruits dissolved in water (rice or corn), fruit juices, etc.

The mash flows through a line 1 through a preheating chamber 19 provided in the interior of a substantially cylindrical latent heat storage device 5. In the preheating chamber 19, line 1 forms a helical region, through which the mash in the line 1 can absorb heat from a thermal oil used as second heat transporting medium. There the temperature of the mash is increased by not more than 4.8° C. in the area of the preheating chamber because otherwise an undesirable sugaring may occur.

After passing through the helical portion lb of line 1 in the preheating chamber 19, the line 1 is led to a combustion chamber 3 of an external boiler. Within the combustion chamber 3, the line 1 again takes a helical shape 1a. Furthermore, a burner 11 is arranged in the combustion chamber 3. Via said burner suitable fuels such as gas, oil, wood or wood products are fired.

The combustion gases and exhaust gases, respectively, occurring from the firing sweep along the helical portion 1a of line 1 and, thus, further heat the mash contained therein to a desired temperature. After passing through the helical portion 1a, the exhaust gases are further conducted to a heat exchanger 13 via a fan 9. A cooled down thermal oil flows through the heat exchanger 13 at a temperature T2 of about 115° C.; this absorbs, in the heat exchanger 13, the heat of the exhaust gas supplied by fan 9 while again reaching a temperature T1 of about 145° C. The thermal oil is pumped through a closed circuit 7 to the latent heat storage device 5 by means of a pump called charging pump 17.

The latent heat storage device 5 essentially consists of an annularly arranged tube bundle shown in section in the schematic views of FIG. 1 and also FIG. 2. The thermal oil conducted through the individual tubes 7a to 7f of the tube bundle thereby dispenses its heat to a phase change material (also referred to as “PCM”) such as salt or paraffin provided in the region of the tubes 7a to 7f. The phase change material is thereby heated, changing its phase from a solid crystalline phase to a liquid phase. Storage spaces for the thermal oil are provided in an input area (in FIG. 1, an upper portion of the latent heat storage device 5) and an output area of the latent heat storage device 5. In said spaces the thermal oil has a temperature T1 of about 145° C. and T2 of about 115° C., respectively.

In the following, different operating modes of the apparatus for heating a fermentable starting material are described.

### Discharge Operation

In a pure discharging operation the charge pump 17 is switched off and the thermal oil is pumped by means of discharge pump 15 through a thermal oil line 7f towards the preheating chamber 19. The latent heat storage device 5 is fully charged, i.e. the phase change material is fully present in a liquid phase. Preferably, paraffin is used as phase change material. The thermal oil is drained from the latent heat storage device 5 via an output terminal 5b and, after having passed through the preheating chamber 19, again introduced into the latent heat storage device 5 via an input terminal 5d. Thus, due to cooling by the cold thermal oil, the paraffin in the latent heat storage device 5 changes to a solid phase. This is exemplarily shown in FIG. 2c, according to which in the figure the thermal oil is removed at the top from the latent heat storage device 5 and is reintroduced into the same at the bottom. The discharge operation can be continued until all the paraffin has changed to the solid phase.

The pure discharge operation is primarily performed when a new beverage production process (brewing process) is started and the external boiler has not yet reached the required operating temperature.

### Parallel Operation

In the parallel operation, part of the thermal oil is led directly through the thermal oil line 7f by means of the discharge pump 15 through the interior of the latent heat storage device and is fed directly to the preheating chamber 19 surrounding the helical section 1b of line 1. Here, it again serves for preheating the mash in the helical area 1b of line 1. As is the case with the thermal oil in the latent heat storage device, the inlet temperature T1 of the thermal oil into chamber 19 is about 145° C., while the outlet temperature T2 is about 115° C. The mash is heated to a temperature of up to a maximum of 98° C. (wort up to 106° C.). Preferably, the direct supply of thermal oil can be feedback controlled by pump 15.

The thermal oil which has flown through the latent heat storage device and through the line 7g and has now cooled down is then pumped back to the heat exchanger 13 by means of the charge pump 17 via the circuit 7 to there again absorb the heat of the exhaust gas. At the same time, a portion of the heated thermal oil flows through the latent heat storage device to at least partially recharge the same, i.e. change solid paraffin into liquid paraffin.

During the parallel operation it is possible, depending on the charge state of the latent heat storage device, to adjust the power supplied to the combustion chamber 3 such that an overcharging of the latent heat storage device is avoided. Preheating in the preheating chamber 19 and heating in the combustion chamber are controlled such that a temperature difference T5−T3 of the mash upstream of the preheating chamber and downstream of the combustion chamber is not more than 5° C. in order to avoid an undesirable saccharification.

During the parallel operation a controller (not shown) ensures that, when excessive discharge of the latent heat storage device 5 occurs, the combustion in the combustion chamber 3 is increased, thereby increasing the exhaust gas temperature as well as the temperature difference T5−T4 of the mash between a point (T5) downstream of the combustion chamber 3 and a point (T4) upstream of the combustion chamber 3 up to an exhaust gas temperature T6 of 168° downstream of the combustion chamber. Accordingly, the controller ensures that the mash is less preheated in the preheating chamber 19, i.e. the temperature difference between a point (T3) upstream of the preheating chamber 19 and a point (T4) downstream of the preheating chamber becomes smaller.

In total, in the case of the embodiment in which a mash is heated as fermentable starting material, the total increase in temperature (T5−T3) of the mash must not exceed 5° C. That is, according to the embodiment, a temperature rise of 4.8° C. of the mash is possible in each of the chambers at maximum thermal oil supply in the preheating chamber 19 or at maximum exhaust gas supply in the combustion chamber 3.

Thus, by the alternately adjusting the combustion power in the combustion chamber 3, on the one hand, and the thermal oil supply to the preheating chamber 19 and the latent heat storage device 5, on the other hand, it is provided that the sum of the two temperature differences T5−T4 and T4−T3 does not exceed the predetermined value.

Therefore, by appropriately adjusting the temperature in the preheating chamber 19, the energy supply in the combustion chamber 3 can be accordingly reduced, which is extremely advantageous in economic terms because fuel can be saved.

### Charging Operation

In the charging operation, the discharge pump 15 is switched off, so that the thermal oil can only flow through the latent heat storage device 5, as it is pumped only by the charge pump 17 in the circuit 7 to the heat exchanger 13 and from the latter back to the input terminal 5a of the latent heat storage device 5. The charging operation is preferably used in the final stage of a beverage production process to prepare the latent heat storage device 5 for the beginning of a subsequent beverage production process.

It is to be noted that the above-mentioned temperatures and temperature differences are to be considered to be an example only on the basis of a mash as starting material to be preheated.

FIGS. 2a) to d) schematically show a charging or discharging operation of a latent heat storage device. As already mentioned above, a liquid, a transitional and a solid phase of the phase change material in the latent heat storage device are indicated by white, cross-hatched or gray filling.

FIG. 2a) shows that, when charging a latent heat storage device with a cold PCM filling, the cold thermal oil is sucked off through an output terminal 5c to be pumped by pump 17 to heat exchanger 13. Then, in a hot state, it again gets through the input terminal 5a into the latent heat storage device 5 where it delivers the heat to the latent heat storage device 5 (in the Fig. from top to bottom). With progressing charge, the PCM begins to liquefy from top to bottom, the overall temperature of the thermal oil circuit starts to rise. In the transition zone between the solid and liquid phases (cold and hot zone), the PCM is liquefied only around the tube bundle, in the hot zone entirely.

According to the invention, the latent heat storage device is considered charged when about 90% of PCM is liquefied.

FIG. 2b) schematically shows the charged state of the latent heat storage device 5.

FIGS. 2c) and 2d) schematically show a state during the discharge. Here, the hot thermal oil is pumped by means of the discharge pump 15 from the latent heat storage device via a terminal 5b, and is then supplied to the preheating chamber 19. The thereby cooled thermal oil is then again fed back (in FIG. 2c) from the bottom) to the latent heat storage device. In this process, the PCM changes its aggregate state from liquid to solid. With progressing discharge the transition zone increases slowly upwards from solid to liquid. Due to a slim design of the latent heat storage device 5 the transition period is kept low. This helps to ensure that, even with progressing discharge, the discharge temperature at the output terminal 5b remains virtually unchanged.

If the outlet temperature of the thermal oil begins to decline, the latent heat storage device is to be regarded as discharged even if a residual amount of heat remains stored (FIG. 2d).

According to the invention, the arrangement of the tube bundle through which the thermal oil is circulating is selected such that there exist approximately equal distances between the core zones of the PCM and the walls of the tube bundle. This is due to the condition of the PCM during the phase change, because said change takes place smoothly from the liquid state to the solid state. In the solid state, the thermal conductivity is very low. For this reason, the distance between the zone of the liquefied PCM and the solidified PCM is relatively uniform and small, so that an appropriate charge and discharge efficiency per unit time is ensured. Dimensioning of the tube bundle is designed such that the total volume of the thermal oil is by no means greater than the total volume of the PCM, since otherwise a precise power feedback control cannot be ensured. Efficiency is further improved if approximately laminar flow conditions are present in the tube bundle.

Since the phase change of the PCM takes place smoothly, the physical properties of the heat have to be considered. Surprisingly, it has been found that the degree of efficiency of the storage capacity increases with the minimization of the transition zone between warm and cold phases. Accordingly, the latent heat storage device is designed as a displacement heat storage device. This means that the latent heat storage device has a maximum vertical orientation with a simultaneous small horizontal expansion. Preferably, the ratio of diameter to construction height is greater than 1:4. The minimization of the height is obtained from the storage capacity of the PCM.

In FIGS. 1 and 2, the thermal oil lines are shown by thick black lines. In addition, in FIG. 1, the thermal oil containing (storage) spaces are illustrated with cross-hatching and the line for the fermentable starting material is shown by a double line. In FIG. 2, the different phases in the heat storage device are indicated by gray shading for the solid phase, cross-hatching for a transitional phase between solid and liquid, and white for the liquid phase.

While the invention has been described with reference to currently preferred embodiments, it shall be noted that the scope of the invention is only defined by the claims attached.

Advantageous modifications and/or combinations of the elements shown in the embodiments are anytime possible. For example, it has been described by means of the embodiment, that the exhaust gases are drawn by a fan to the heat exchanger in which the thermal oil is heated. Advantageously, one may also provide an arrangement in which another pneumatic pump is provided instead of the fan, or a flow of the exhaust gas to the heat exchanger is caused by structural measures such as appropriate lines or branches. Feedback control of the exhaust gas supply to the heat exchanger can also be dispensed with completely.

According to embodiment, the latent heat storage device has been described as being substantially cylindrical. Alternatively, the latent heat storage device used may e.g. consist of two storage tanks having a tube bundle package inside. The distribution chamber may be located at one end of the storages, to which the hot thermal oil flows at a temperature T1. After flowing through the individual tubes of the tube bundle, the then cooled down thermal oil can be collected in a collection chamber at a temperature T2 before it is again discharged from the latent heat storage device.

As the storage medium, a paraffin is preferably used, which liquefies at approximately 145° C. and the recrystallization of which begins when being cooled down below 130° C. and is completed at about 120° C. Depending on the size of the latent heat storage device, in this way comparably large energy amounts of heat energy can be stored, adapted to be stored and discharged in a very short time.

Advantageously, a charge of the energy storage can only be made when the exhaust gases from the burner are sufficiently hot, or the thermal oil being pumped through the combustion chamber has reached an appropriate temperature.

Advantageously, with a longer external boiling process direct heat recovery for preheating the mash in the helical area lb can be performed, even when the heat storage device is already charged.

Advantageously, the device (the external boiler) for heating a fermentable starting material can also be operated if the latent heat storage device has a malfunction and for this reason cannot be used.

The direct supply of the thermal oil to the chamber surrounding the helical region of the line within the latent heat storage device is feedback controlled via the pump. Alternatively or additionally, also check valves or the like may be provided to enable or block a flow through the oil line directly to the chamber surrounding the helical region of the line within the latent heat storage device.

Although it has been described with reference to the embodiment that the control is made on the basis of the temperatures of the thermal oil and the combustion exhaust gas, it is not limited thereto but can also be made on the basis of a phase state of the PCM in the latent heat storage device 5. The following states can be distinguished; these are for example recognized by the controller by means of appropriate sensors:

Cold (Cold): The PCM is solid and its temperature is less than 100° C.;

Low (Low): the temperature of the PCM is located at the lower phase change temperature;

Economizing (economizing): the temperature of the PCM is located in the center of the phase change temperature range;

Fully Charged (Fully Charged): The PCM is liquefied;

Overcharged (Overcharged): the PCM temperature is above 160° C.

The charge power and discharge power are then controlled in accordance with the state of charge.

A preferred target of the control is to have the latent storage device completely charged at the end of the brewing process, i.e. after the energy-intensive wort cooking under pressure, so that, for a following brew, the initially lower brewing product temperatures are achieved mainly from the stored heat of the latent heat storage device in the preheating chamber (discharging operation) and only upon entry in the phase change region, that is, at a temperature of the thermal oil between 120° C. and 130° C. charging is again initiated.

By using alternative phase-change materials and/or heat transport media, other temperature ranges than the above-mentioned ones can be achieved, which are only given as examples mentioned with reference to an exemplary brewing process (heating of mash and/or wort).

1. A device for heating a fermentable starting material for beverage production, comprising:
a line which is arranged inside a combustion chamber and by which part of a heat outputted from a heat source in the combustion chamber by a first heat transporting medium is transferable to the fermentable starting material flowing in the line,
a heat storage device provided downstream of the combustion chamber for storing part of the residual heat transported by the first heat transporting medium, said line being arranged such that, upstream of the combustion chamber, preheating of the fermentable starting material flowing in the line takes place in a preheating chamber by the heat stored in the heat storage device.

2. The device for heating a fermentable starting material according to claim 1, wherein
a transfer of part of the residual heat takes place between the combustion chamber and the heat storage device from the first heat transporting medium to a second heat transporting medium.

3. The device for heating a fermentable starting material according to claim 2, wherein the first heat transporting medium is a gas, preferably an exhaust gas of a combustion, and the second heat transporting medium is a liquid, preferably a thermal oil or water.

4. The device for heating a fermentable starting material according to claim 2, wherein the transfer of part of the residual heat from the first heat transporting medium to the second heat transporting medium is effected by means of a branch, a switching valve, a fluid pump or a fan.

5. The device for heating a fermentable starting material according to claim 2, wherein the transfer of part of the residual heat from the first heat transporting medium to the second heat transporting medium is effected when the first heat transporting medium has a predetermined minimum temperature.

6. The device for heating a fermentable starting material according to claim 1, wherein the heat storage device is formed as at least one latent heat storage device, in which a transfer of heat takes place from the heat transporting medium to a phase change material in the latent heat storage device, or vice versa.

7. The device for heating a fermentable starting material according to claim 6, wherein
a salt or a paraffin is used as phase change material,
the condensation temperature thereof preferably being between 130° C. and 150° C. and the recrystallization temperature thereof preferably being between 130° C. and 120° C.

8. The device for heating a fermentable starting material according to claim 6, wherein
control means are provided for controlling a supply of the second heat transporting medium to the pre-heating chamber and/or the latent heat storage device based on a temperature of the first heat transporting medium downstream of the combustion chamber and/or a temperature of the second heat transporting medium downstream of the pre-heating chamber.

9. The device for heating a fermentable starting material according to claim 8, wherein the control means are provided in the form of a charge pump and a discharge pump,
the charge pump in a switched-on state and the discharge pump in a switched-off state causing a flow of the second heat transporting medium through the latent heat storage device in a first direction,
the charge pump in a switched-off state and the discharge pump in a switched-on state causing a flow of the second heat transporting medium through the pre-heating chamber and the latent heat storage device in a second direction, and
the charge pump in a switched-on state and the discharge pump in a switched-on state causing a flow of the second heat transporting medium through the pre-heating chamber and the latent heat storage device in the first direction.

10. A method for heating a fermentable starting material for beverage production, comprising the steps of:
transporting the fermentable starting material through a line,
heating the fermentable starting material by transferring part of a heat outputted from a heat source via a heat transporting medium to the fermentable starting material flowing in the line in a combustion chamber,
storing part of the residual heat transported by the heat transporting medium in a heat storage device downstream of the combustion chamber, and
preheating the fermentable starting material flowing in the line upstream of the combustion chamber by the heat stored in the heat storage device in a pre-heating chamber.

11. The method for heating a fermentable starting material according to claim 10, wherein
part of the residual heat is transferred between the combustion chamber and the heat storage device from the first heat transporting medium to a second heat transporting medium.

12. The method for heating a fermentable starting material according to claim 11, wherein the first heat transporting medium is a gas, preferably an exhaust gas of a combustion, and the second heat transporting medium is a liquid, preferably a thermal oil or water, which is conducted in a closed circuit conducted via the heat storage device.

13. The method for heating a fermentable starting material according to claim 10, wherein heat is transferred from one of the heat transporting media to a phase-change material in the heat storage device formed as at least one latent heat storage device, or vice versa.

14. The method for heating a fermentable starting material according to claim 13, wherein
a) the preheating of the fermentable starting material flowing in the line is effected in the pre-heating chamber by discharging the latent heat storage device, by causing the second heat transporting medium to flow from the latent heat storage device to the pre-heating chamber when the temperature of the first heat transporting medium is below a predetermined limit temperature,
b) the preheating of the fermentable starting material flowing in the line is effected in the pre-heating chamber while the latent heat storage device is charged, by causing the second heat transporting medium to flow in a closed circuit via a heat exchanger at which heat is transferred from the first heat transporting medium to the second heat transporting medium, through the latent heat storage device and the pre-heating chamber, and
c) only a charging of the latent heat storage device is effected by causing an access to the pre-heating chamber to be blocked while the second heat transporting medium flows in the closed circuit via the heat exchanger at which heat is transferred from the first heat transporting medium to the second heat transporting medium, and through the latent heat storage device.

15. The method for heating a fermentable starting material according to claim 14, wherein
step a) is carried out as long as a temperature of the first heat transporting medium downstream of the combustion chamber is below a predetermined minimum temperature and a minimum proportion of the phase change material is available in liquid form,
step b) is carried out when the temperature of the first heat transporting medium has exceeded the predetermined minimum temperature downstream of the combustion chamber,
step c) is carried out when the temperature of the first heat transporting medium has exceeded a predetermined charging temperature downstream of the combustion chamber.

16. The method for heating a fermentable starting material according to claim 14, wherein,
in step b), a temperature feedback control in the combustion chamber is carried out in dependence on a temperature difference of the fermentable starting material between a point upstream of the pre-heating chamber and downstream of the combustion chamber.
